(19) United States
(12) Patent Application Publication
(10) Pub. No.: US 2020/0149619 A1
(43) Pub. Date: May 14, 2020

(54) TIMING SYSTEM OF ENGINE

(71) Applicants: HYUNDAI MOTOR COMPANY, Seoul (KR); KIA MOTORS CORPORATION, Seoul (KR)

(72) Inventors: Sung Il Jung, Anyang-si (KR); Jong Won Lee, Hwaseong-si (KR); Woong Na, Hwaseong-si (KR)

(21) Appl. No.: 16/202,837

(22) Filed: Nov. 28, 2018

(30) Foreign Application Priority Data
Nov. 8, 2018 (KR) 10-2018-0136631

(51) Int. Cl. F16H 37/06; F01M 1/02; F02B 63/06; F16H 57/031; F16H 57/025; F16H 57/035; B60T 17/02

(52) U.S. Cl. CPC F16H 37/065; F01M 1/02; F02B 63/06; F01M 2001/0269; F16H 57/025; F16H 57/035; B60T 17/02; F16H 57/031

(57) ABSTRACT

The present disclosure relates to a timing system of an engine, which is capable of coping with a pneumatic brake system requiring high drive torque without changing a cylinder block, a cylinder head, and a valve train. The timing system includes a gear train mechanism configured to transmit power of a crankshaft to an air compressor and a high pressure pump via gear transmission, a first chain mechanism configured to transmit the power transmitted to the high pressure pump to a camshaft via chain transmission, and a second chain mechanism configured to transmit the power of the crankshaft to an oil pump via chain transmission.

### CROSS REFERENCE TO RELATED APPLICATION

The present application claims priority to Korean Patent Application No. 10-2018-0136631, filed Nov. 8, 2018, the entire contents of which is incorporated herein for all purposes by this reference.

### BACKGROUND

### Field of the Disclosure

The present disclosure relates to a timing system of an engine, which is capable of coping with a pneumatic brake system requiring high drive torque without changing a cylinder block, a cylinder head, a valve train, and the like.

### Description of the Related Art

In order to improve the fuel efficiency of a vehicle and reduce the material cost, the downsizing of the engine has been actively applied, and thus, an effort has been made to apply the 2 to 3 L engine, which is commonly applied to a conventional small commercial vehicle, to a large truck, to which a 4 L engine is commonly mounted.

However, due to the nature of trucks carrying heavy objects, a large commercial vehicle requires a pneumatic brake system rather than a conventional hydraulic brake system for safe and smooth braking.

To achieve this, a pneumatic air compressor must be provided in an engine, but the drive torque of the air compressor is too high to be coped with by the chain and timing belt systems used in most of the conventional 2 to 3 L engines, so it is inevitable to considerably change the engine on the premise of changing components of a cylinder block, a cylinder head, and a valve train.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a timing system of an engine, which is capable of coping with a pneumatic brake system requiring high drive torque without changing a cylinder block, a cylinder head, a valve train, and the like.

In order to achieve the above object, according to some aspects of the present disclosure, there is provided a timing system of an engine, the timing system including: a gear train mechanism configured to transmit power of a crankshaft to an air compressor and a high pressure pump via gear transmission; a first chain mechanism configured to transmit the power transmitted to the high pressure pump to a camshaft via chain transmission; and a second chain mechanism configured to transmit the power of the crankshaft to an oil pump via chain transmission.

The gear train mechanism may include: a crankshaft gear assembled to the crankshaft; a first idle gear externally engaged with the crankshaft gear; a high pressure pump gear assembled to the high pressure pump and externally engaged with the first idle gear; a second idle gear externally engaged with the first idle gear; and an air compressor gear assembled to the air compressor and externally engaged with the second idle gear.

The first idle gear is disposed at an upper portion of a first side of the crankshaft gear; the high pressure pump gear is disposed at an upper portion of a first side of the first idle gear; the second idle gear is disposed at a lower portion of a first side of the first idle gear; and the air compressor gear is disposed on a first side of the second idle gear.

Axes of the crankshaft gear, the first idle gear, and the high pressure pump gear may be arranged in approximately a straight line; and axes of the crankshaft gear, the second idle gear, and the air compressor gear may be arranged in approximately a straight line.

The second idle gear may be disposed at a position directly under the high pressure pump gear, such that the air compressor gear is disposed at a lower portion of a first side of the high pressure pump gear.

The first chain mechanism may include: a high pressure pump sprocket coaxially assembled with the high pressure pump gear; and a cam sprocket assembled to the camshaft and connected with the high pressure pump sprocket by an upper chain, and the second chain mechanism may include: a crankshaft sprocket coaxially assembled with the crankshaft gear; and an oil pump sprocket assembled to the oil pump and connected with the crankshaft sprocket by a lower chain.

The cam sprocket may be disposed at an upper portion of a second side of the high pressure pump sprocket; and the oil pump sprocket may be disposed at a lower portion of a second side of the crankshaft sprocket.

A gear casing may be coupled to a cylinder block and a cylinder head of an engine; the high pressure pump and the air compressor may be coupled to a rear surface of the gear casing; and the first idle gear and the second idle gear may be coupled to a front surface of the gear casing.

A gear cover may be coupled to the gear casing to surround the front surface thereof; and between the gear casing and the gear cover, the crankshaft gear and the crankshaft sprocket, the high pressure pump gear and the high pressure pump sprocket, the first idle gear and the second idle gear, the air compressor gear, and the cam sprocket may be provided.

The gear cover may be provided with a detachable plug at a part thereof facing the high pressure pump sprocket.

According to the present disclosure, it is advantageous in that a pneumatic brake system can be applied to a light commercial vehicle through an engine timing system that combines a gear drive and a chain drive, thereby contributing to improvement of the marketability of a vehicle.

It is further advantageous in that a gear engagement structure with high torque transmission efficiency is applied to the air compressor and the high pressure pump, in which a drive torque is large and a high strength of a transmission system is important, and a timing chain system is applied to the camshaft and the oil pump, which have low transmission torque, to make the overall layout of an engine compact and to reduce weight.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is an exploded view showing a gear casing and a gear cover along with a connection configuration of a gear train mechanism and a chain mechanism according to the present disclosure;

FIG. 2 is a view showing gear engagement of the gear train mechanism according to the present disclosure;

FIG. 3 is a view showing a state where a high pressure pump sprocket is assembled to a high pressure pump gear according to the present disclosure; and

FIG. 4 is a view showing a shape of a second idle gear according to the present disclosure.

### DETAILED DESCRIPTION OF THE DISCLOSURE

Hereinbelow, an exemplary embodiment of the present disclosure will be described in detail with reference to the accompanying drawings.

A timing system of an engine of the present disclosure roughly includes: a gear train mechanism A; a first chain mechanism B; and a second chain mechanism C.

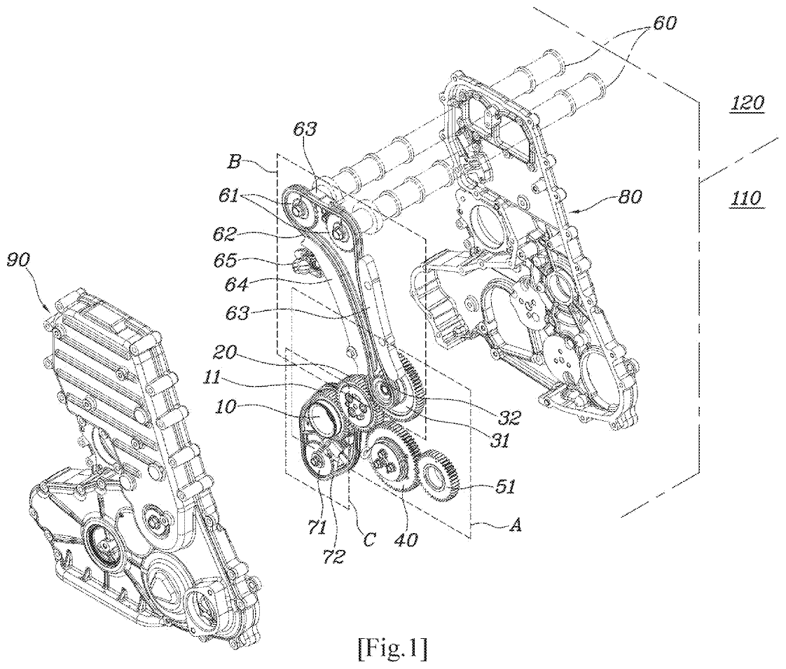

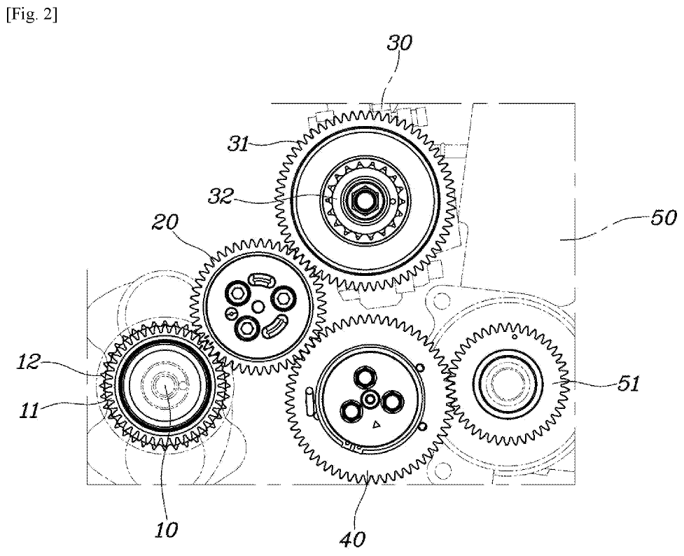

Referring to FIGS. 1 and 2, firstly, the gear train mechanism A is configured to transmit power of a crankshaft 10 to an air compressor 50 and a high pressure pump 30 via gear transmission.

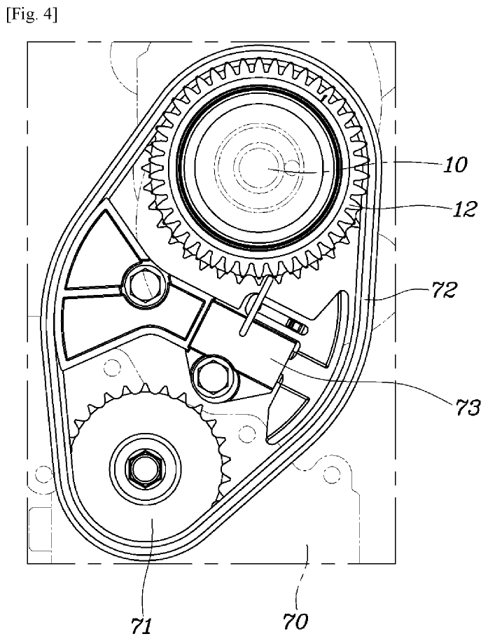

Further, the first chain mechanism B is configured to transmit the power transmitted to the high pressure pump 30 to a camshaft 60 via chain transmission; and the second chain mechanism C is configured to transmit the power of the crankshaft 10 to an oil pump 70 (shown in FIG. 4) via chain transmission.

In other words, a gear engagement structure with high torque transmission efficiency is applied to the air compressor 50 and the high pressure pump 30, in which a drive torque is large and a high strength of a transmission system is important, whereby reliability of torque transmission is ensured; and a timing chain system is applied to the camshaft 60 and the oil pump 70, which have low transmission torque, to make the overall layout of an engine 100 compact and to reduce weight.

To be more specific to the configuration of the gear train mechanism A, a crankshaft gear 11 is assembled to the crankshaft 10, and a first idle gear 20 is externally engaged with the crankshaft gear 11.

Further, a high pressure pump gear 31 is connected to the high pressure pump 30, the high pressure pump gear 31 is externally engaged with the first idle gear 20, and a second idle gear 40 is also externally engaged with the first idle gear 20.

Further, an air compressor gear 51 is connected to the air compressor 50, and the air compressor gear 51 is externally engaged with the second idle gear 40.

For example, the crankshaft gear 11 is a spur gear that is hot shrink-fitted into the nose of the crankshaft 10 to rotate at the same speed as the crankshaft 10, and transmits the torque to the first idle gear 20.

Further, the first idle gear 20 receives the torque from the crankshaft 10, is engaged with the high pressure pump gear 31 and transmits the torque to the high pressure pump 30. Here, depending on the number of teeth of the crankshaft gear 11, the first idle gear 20, and the high pressure pump gear 31, the high pressure pump gear 31 is rotated two-thirds per revolution of the crankshaft 10.

In addition, the first idle gear 20 transmits the torque also to the second idle gear 40, and the second idle gear 40 is engaged with the air compressor 50 and transmits the torque to the air compressor 50. Here, depending on the number of teeth of the crankshaft gear 11, the first idle gear 20, the second idle gear 40, and the air compressor gear 51, the air compressor gear 51 is rotated once per revolution of the crankshaft 10.

Further, as shown in FIG. 4, the second idle gear 40 is applied with a scissors gear to reduce backlash and reduce rattle noise.

Referring to FIG. 2, as for the arrangement of the gears constituting the gear train mechanism A, based on the drawing, the first idle gear 20 is disposed at a position diagonal to the upper right side of the crankshaft gear 11, and the high pressure pump gear 31 is disposed at a position diagonal to the upper right side of the first idle gear 20.

Further, the second idle gear 40 is disposed at a position diagonal to the lower right side of the first idle gear 20, and the air compressor gear 51 is disposed on the right side of the second idle gear 40.

In addition, axes of the crankshaft gear 11, the first idle gear 20, and the high pressure pump gear 31 are arranged in approximately a straight line; and axes of the crankshaft gear 11, the second idle gear 40, and the air compressor gear 51 are arranged in approximately a straight line.

According to this arrangement, the second idle gear 40 is disposed at a position directly under the high pressure pump gear 31, and the air compressor gear 51 is disposed at a position diagonal to the lower right side of the high pressure pump gear 31.

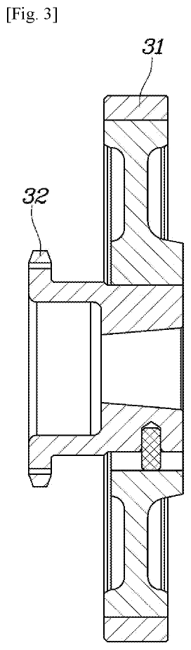

Meanwhile, referring to FIGS. 1 and 3, as for the configurations of the first chain mechanism B and the second chain mechanism C, the first chain mechanism B is configured such that a high pressure pump sprocket 32 is coaxially assembled with the high pressure pump gear 31.

Further, a cam sprocket 61 is assembled to the camshaft 60, and the cam sprocket 61 is connected with the high pressure pump sprocket 32 by an upper chain 62.

In other words, the power transmitted from the crankshaft 10 is transmitted to the camshaft 60 through the upper chain 62.

To be more specific to the configuration of the first chain mechanism B, a plurality of chain guides 63 are provided to maintain the layout of the chain and to prevent the occurrence of the vibration, a chain lever 64 is provided to maintain the layout while rotating about a pivot point, so as to apply appropriate tension to the chain, and a hydraulic tensioner 65 is provided to apply a predetermined tension by being brought in contact with the chain lever.

Here, the hydraulic tensioner 65 receives oil with a predetermined pressure through an oil line connected from a gear cover 90 and forms hydraulic damping to attenuate the vibration of the upper chain 62.

In addition, the second chain mechanism C is configured such that a crankshaft sprocket 12 is coaxially assembled with the crankshaft gear 11.

Further, an oil pump sprocket 71 is connected to the oil pump 70, and the oil pump sprocket 71 is connected with the crankshaft sprocket 12 by a lower chain 72.

Further, an oil pump tensioner 73 may be provided to maintain the layout and tension of the chain.

In other words, the power transmitted from the crankshaft 10 is transmitted to the oil pump 70 through the lower chain 72.

Referring to FIG. 1, as for the arrangement of each sprocket constituting the first chain mechanism B and the second chain mechanism C, based on the drawing, two cam sprocket 61 are disposed at a position diagonal to the upper left side of the high pressure pump sprocket 32 while being arranged parallel to each other.

Further, the oil pump sprocket 71 is disposed at a position diagonal to the lower left side of the crankshaft sprocket 12.

Meanwhile, the present disclosure is configured such that gears and sprockets included in the gear train mechanism A and the chain mechanism are provided between a gear casing 80 and the gear cover 90.

Referring to FIG. 1, the gear casing 80 is coupled to a cylinder block 110 and a cylinder head 120 of the engine 100, and the high pressure pump 30 and the air compressor 50 are coupled to the rear surface of the gear casing 80.

Further, the first idle gear 20 and the second idle gear 40 are rotatably coupled to the front surface of the gear casing 80.

For example, the gear casing 80 is coupled to the cylinder block 110 and the cylinder head 120 to function as a bolt anchor point, a seat surface, and oil supply for components of the power transmission system, and is finally assembled with the gear cover 90 after the components of the power transmission system are assembled to protect internal components and seal.

For reference, the purified oil having a predetermined pressure can be supplied from the cylinder block 110 through an internal oil passage formed in the gear casing 80, and the oil can be delivered into the first idle gear 20 and the second idle gear 40 through a through-hole of the seat surface.

Further, the delivered oil is used to lubricate the bearings between the gears, and the shafts of the idle gears through the internal oil passage of each idle gear.

Further, the oil is supplied from the oil hole of the cylinder head 120 through the upper rear surface of the gear casing 80, and the supplied oil is supplied into the chain tensioner through the reservoir provided at the center of the seat surface of the chain tensioner.

In addition, the gear cover 90 is coupled to the gear casing 80 to surround the front surface thereof.

Further, between the gear casing 80 and the gear cover 90, the crankshaft gear 11 and the crankshaft sprocket 12, the high pressure pump gear 31 and the high pressure pump sprocket 32, the first idle gear 20 and the second idle gear 40, the air compressor gear 51, and the cam sprocket 61 are provided.

For reference, the gear cover 90 is coupled to the gear casing 80 and the oil pump 70, to protect internal components and seal and to serve as a shield against vibration and noise generated from the power transmission system.

Further, by an oil seal press-fitted in the gear cover 90, the oil around the nose of the crankshaft 10 is prevented from leaking outside.

In addition, the gear cover 90 is provided with a detachable plug at a part thereof facing the high pressure pump sprocket 32, such that a space for entrance of the tools is provided without removing the gear cover 90 when the high pressure pump sprocket and the high pressure pump 30 are serviced.

As described above, according to the present disclosure, a pneumatic brake system can be applied to a light commercial vehicle through an engine timing system that combines a gear drive and a chain drive, thereby contributing to improvement of the marketability of a vehicle.

In other words, a gear engagement structure with high torque transmission efficiency is applied to the air compressor 50 and the high pressure pump 30, in which a drive torque is large and a high strength of a transmission system is important, and a timing chain system is applied to the camshaft 60 and the oil pump 70, which have low transmission torque, to make the overall layout of an engine 100 compact and to reduce weight.

While a number of exemplary aspects have been discussed above, those of skill in the art will recognize that still further modifications, permutations, additions and sub-combinations thereof of the disclosed features are still possible. It is therefore intended that the following appended claims and claims hereafter introduced are interpreted to include all such modifications, permutations, additions and sub-combinations as are within their true spirit and scope.

1. A timing system of an engine, the timing system comprising:
a gear train mechanism configured to transmit power of a crankshaft to an air compressor and a high pressure pump via gear transmission;
a first chain mechanism configured to transmit the power transmitted to the high pressure pump to a camshaft via chain transmission; and
a second chain mechanism configured to transmit the power of the crankshaft to an oil pump via chain transmission.

2. The timing system of claim 1, wherein the gear train mechanism includes:
a crankshaft gear assembled to the crankshaft;
a first idle gear externally engaged with the crankshaft gear;
a high pressure pump gear assembled to the high pressure pump and externally engaged with the first idle gear;
a second idle gear externally engaged with the first idle gear; and
an air compressor gear assembled to the air compressor and externally engaged with the second idle gear.

3. The timing system of claim 2, wherein the first idle gear is disposed at an upper portion of a first side of the crankshaft gear;
the high pressure pump gear is disposed at an upper portion of a first side of the first idle gear;
the second idle gear is disposed at a lower portion of a first side of the first idle gear; and
the air compressor gear is disposed on a first side of the second idle gear.

4. The timing system of claim 3, wherein axes of the crankshaft gear, the first idle gear, and the high pressure pump gear are arranged in approximately a straight line; and
axes of the crankshaft gear, the second idle gear, and the air compressor gear are arranged in approximately a straight line.

5. The timing system of claim 3, wherein the second idle gear is disposed at a position directly under the high pressure pump gear, such that the air compressor gear is disposed at a lower portion of a first side of the high pressure pump gear.

6. The timing system of claim 3, wherein the first chain mechanism includes:
a high pressure pump sprocket coaxially assembled with the high pressure pump gear; and
a cam sprocket assembled to the camshaft and connected with the high pressure pump sprocket by an upper chain, and
the second chain mechanism includes:
a crankshaft sprocket coaxially assembled with the crankshaft gear; and
an oil pump sprocket assembled to the oil pump and connected with the crankshaft sprocket by a lower chain.

7. The timing system of claim 6, wherein the cam sprocket is disposed at an upper portion of a second side of the high pressure pump sprocket; and
the oil pump sprocket is disposed at a lower portion of a second side of the crankshaft sprocket.

8. The timing system of claim 6, wherein a gear casing is coupled to a cylinder block and a cylinder head of an engine;
the high pressure pump and the air compressor are coupled to a rear surface of the gear casing; and
the first idle gear and the second idle gear are coupled to a front surface of the gear casing.

9. The timing system of claim 8, wherein a gear cover is coupled to the gear casing to surround the front surface thereof; and
between the gear casing and the gear cover, the crankshaft gear and the crankshaft sprocket, the high pressure pump gear and the high pressure pump sprocket, the first idle gear and the second idle gear, the air compressor gear, and the cam sprocket are provided.

10. The timing system of claim 9, wherein the gear cover is provided with a detachable plug at a part thereof facing the high pressure pump sprocket.
